(19) United States
(12) Patent Application Publication
(10) Pub. No.: US 2016/0282048 A1
(43) Pub. Date: Sep. 29, 2016

(54) METALLURGICAL FURNACE PROBE WITH EJECTING CARTRIDGE SENSOR

(71) Applicant: EMPCO (CANADA) LTD., Whitby (CA)

(72) Inventor: Edgar R. Wunsche, Whitby (CA)

(21) Appl. No.: 15/036,658

(22) PCT Filed: Oct. 29, 2014
(86) PCT No.: PCT/CA2014/000779

§ 371 Date: May 13, 2016

Related U.S. Application Data
(60) Provisional application No. 61/903,670, filed on Nov. 13, 2013.

(51) Int. Cl. F27D 21/00; F27B 3/28

(52) U.S. Cl. CPC F27D 21/0014; F27B 3/28; F27D 2201/00; F27D 2019/0084

(57) ABSTRACT

A mechanical probe apparatus for taking measurements with a sensor cartridge inside a metallurgical furnace. The apparatus has a housing, and a mounting member to receive the sensor cartridge, the mounting member being movable from being withdrawn in the housing to extending outside of the housing. The housing, itself, is movable from being exterior of the furnace to a position wherein a portion of the housing extends into the furnace through a portal. The sensor cartridge can be mounted to the mounting member when the housing is exterior of the furnace and the mounting member extends outside of the housing. The sensor cartridge can then be withdrawn into the housing on the mounting member and the housing can subsequently be moved into the furnace. Thereafter the sensor can be extended outside of the housing to take measurements when the housing is within the furnace. The apparatus also includes an ejector for releasing the sensor from the mounting member when the housing is within the furnace, after the measurements have been taken.

### TECHNICAL FIELD

The present subject matter relates to a mechanized probe apparatus for use with a metallurgical furnace such as the type used in steelmaking operations.

### BACKGROUND

In metallurgical operations, it is well known to periodically insert a sensor probe into the furnace in order to obtain status information about the steel bath, particularly, its temperature, carbon and oxygen parameters, and other aspects of the chemical composition.

The probes usually include a replaceable sensor cartridge which is mounted before the probe is inserted into the furnace. Commonly, an operator manually inserts the measuring probe into the furnace through the slag door, which is a relatively wide opening in the wall of the furnace shell. In order to insert the probe through the slag layer and into the molten steel bath, the operator must approach close to the open slag door, thereby being exposed to extreme heat from within the furnace. After the measurements have been taken, the operator withdraws the probe from the furnace and manually removes the spent measuring cartridge from the probe, which exposes the operator to a risk of hand burns.

In an effort to reduce the risk of injury to workers, mechanized devices have been proposed for inserting the measuring probe into the furnace interior. However, all such known devices are based on inserting the probe through the slag door as in manual operations.

Inserting the probe through the slag door has a number of operational disadvantages in addition to risking worker safety. It wastes energy because there is a large intake of cold ambient air through the slag door when it is opened. The air becomes heated in the furnace and is subsequently exhausted as a high-temperature waste gas. In addition, opening the slag door for insertion of the measuring probe can cause premature discharge of slag that has not been fully processed.

It is an object of the present subject matter to address these and other disadvantages of known equipment and methods for measuring temperature and bath chemistry in a metallurgical furnace.

### SUMMARY

The following summary is intended to introduce the reader to the more detailed description that follows, and not to define or limit the claimed subject matter.

According to one aspect, the present subject matter provides a mechanical probe apparatus for taking measurements with a sensor cartridge inside a metallurgical furnace. The apparatus comprises a housing, and a mounting member adapted to releasably receive the sensor cartridge, with the mounting member being movable from a normal first position wherein it is withdrawn in the housing, to a second position wherein it extends outside of the housing. The housing is movable between a position entirely exterior of the furnace to a position wherein a portion of the housing extends into the furnace through a dedicated probe portal.

The apparatus also comprises a closure for substantially closing the portal when the housing is in a position exterior of the furnace.

The mounting member can be moved to either its first or second position both when the housing is in a position entirely exterior of the furnace and when the housing is in the position wherein a portion of the housing extends into the furnace. Thereby, when the housing is in a position entirely exterior of the furnace and the mounting member is moved to its second position, the sensor cartridge can be mounted to the mounting member and then withdrawn into the housing as the mounting member is moved back to its first position. Moreover, when the housing is subsequently moved to the position wherein a portion of the housing extends into the furnace, the sensor cartridge can be extended outside of the housing to take measurements as the mounting member is moved again to its second position.

The apparatus also comprises an ejector for releasing the sensor from the mounting member when the housing is in the position wherein a portion of the housing extends into the furnace after the measurements have been taken.

In some embodiments, the ejector comprises a compressed gas supply for blowing the sensor off the mounting member after the measurements have been taken. In some embodiments, the ejector comprises a barrier for stripping the sensor off the mounting member as the mounting member is withdrawn back into the housing after the measurements have been taken. In some embodiments the injector comprises an extendable element for pushing the sensor off the mounting member after the measurements have been taken.

In some embodiments, the portal is dimensioned to closely accommodate the portion of the housing extending into the furnace. In some examples, the furnace has a slag door, and the portal is separate from the slag door. In some examples, the portal is remote from the slag door.

In some examples, the housing is mounted on an arm that pivots. In some embodiments, the housing rotates on the pivoting arm. In some embodiments, both the arm pivots and the housing rotates in a substantially vertical plane.

In some embodiments, the housing has a linear portion. In some examples, the housing also has a curved portion from which the linear portion extends.

In some examples, the mounting member comprises a pole, which may be a tubular pole. In some examples, the pole can be pushed and pulled within the housing by means of a linkage. In some examples, the linkage comprises a roller chain. In some embodiments, the roller chain is activated by a rotary actuator.

In some embodiments, the housing includes a liquid cooling circuit. In some examples, the housing further comprises a compressed air supply.

In some embodiments, the housing is further movable to additional positions exterior of the furnace.

In some embodiments, the apparatus further comprises a control system for automatically controlling the movement of the housing, and for controlling the opening and closing of the closure of the portal, and for controlling the extension and retraction of the mounting member.

### BRIEF DESCRIPTION OF DRAWINGS

In order that the claimed subject matter may be more fully understood, reference will be made to the accompanying drawings, in which:

FIG. 1 is a schematic elevation view, partially in cross-section, showing a mechanized probe apparatus for a metallurgical furnace, the apparatus being shown in a first position, according to one embodiment;

FIG. 2 is a similar view of the same apparatus in a second position;

FIG. 3 is a similar view of the same apparatus in a third position;

FIG. 4 is a similar view of the same apparatus in a fourth position;

FIG. 5 is a similar view of the same apparatus in a fifth position;

FIG. 6 is a similar view of the same apparatus in a sixth position;

FIG. 7 is a similar view of the same apparatus in a seventh position;

FIG. 8 is a similar view of the same apparatus in an eighth position.

### DETAILED DESCRIPTION OF EMBODIMENTS

In the following description, specific details are set out to provide examples of the claimed subject matter. However, the embodiments described below are not intended to define or limit the claimed subject matter. It will be apparent to those skilled in the art that many variations of the specific embodiments may be possible within the scope of the claimed subject matter.

As shown in the drawings, a mechanized probe apparatus 30 comprises a closure assembly 6 and a probe insertion assembly 15. The mechanized probe apparatus 30 is mounted to the steel structure of the shell of a metallurgical furnace lined with refractory 2 and containing molten steel 3. The vertical wall 4 of the shell 1 is provided with a portal 5 in which is installed the aforementioned closure assembly 6. The closure assembly 6 is water cooled and is remotely controlled to be normally in a closed position, but it can be opened for the purpose of inserting the probe into the high-temperature operating chamber 16 of the furnace for taking measurements of temperature, bath chemistry, and so forth.

The probe insertion assembly 15 comprises several sub-assemblies: a probe housing 10, with a generally linear portion 24 and a curved portion 17; a push-pull driving mechanism 29; a retractable pole 22 upon which replaceable sensor cartridges 23 can be mounted; and a pivoting frame arm 19.

The linear portion 24 of the housing 10 is rugged and includes intense liquid media cooling, with the inside of the cooling circuit area outfitted with compressed air piping. The linear portion 24 of the housing 10 may be provided with a replaceable air cooled end protector 12. The other end of the linear portion 24 is provided with a bolting flange 25 for mechanically connecting the linear portion 24 to a counter plate flange 26 of the curved portion 17. The linear portion 24 has an initial elbow 27 such that it extends tangentially from the curved portion 17.

The retractable cartridge pole 22 extends through the linear portion 24 connecting to the push-pull driving mechanism 29 which is in turn connected to a hydraulic rotating actuator 18. The retractable pole 22 can carry different length cartridges 23 with appropriate sensors at their free end. The pole 22 is advantageously connected to the push-pull driving mechanism by means of a connection that facilitates easy removal and replacement of the pole from time to time.

The frame arm 19 is connected to the wall 4 of the furnace (or alternatively to the furnace platform) through a rotation bushing 20. The frame arm 19 is thus pivotable in a vertical plane controlled by a linear motion hydraulic cylinder 21. At its free end, the frame arm 19 carries the housing 10, the curved portion 17 having a second hydraulic rotator via a shaft and bushing, not shown, thereby allowing inter-dependent pivoting of the frame arm 19 and rotating of the probe housing 10 for repositioning the probe insertion assembly 15 away from the furnace to facilitate placement of the replaceable measuring cartridges 23 on the pole 22.

The push-pull driving mechanism 29 comprises a quasi roller chain linkage extending from the retractable cartridge pole 22 to an arm 28 that is connected to the hydraulic rotating actuator 18. The hydraulic rotating actuator 18 can thereby provide rapid reciprocating motion of the pole 22, and thereby provide rapid retraction of the cartridge 23 within the linear portion 24 of the probe housing 10, and also subsequently rapid extension of the pole 22 and cartridge 23 when the probe insertion assembly 15 is in the position for taking measurements. During such measurements, the pole 22 carrying a cartridge 23 is submerged for a period into the molten steel 3 followed by rapid withdrawal as soon as the measurements have been taken.

Thus, the probe insertion assembly 15 comprises: the probe housing 10 which can rotate on the swing arm 19; the swing arm 19 which can raise the probe housing 10 from a position remote from the furnace to a position contiguous to the furnace shell; and the push-pull driving mechanism 29 which can extend or retract the pole 22 to which the measurement cartridge 23 can be mounted.

The closure assembly 6 is adapted to open the portal 5 so as to permit the linear portion 24 of the probe housing 10 to be inserted into the furnace. At other times, the closure assembly 6 maintains the portal 5 closed.

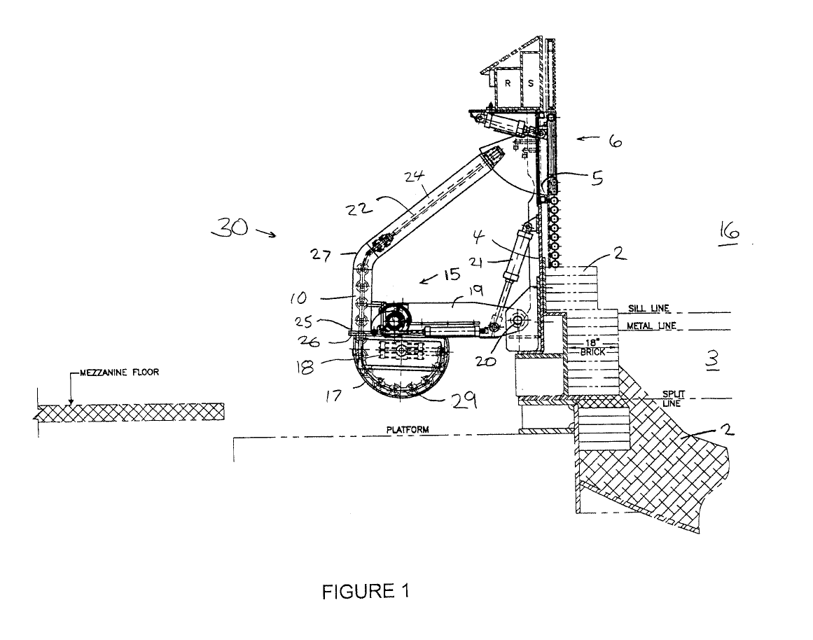

As shown in FIG. 1, the probe insertion assembly 15 is shown in a parked position, such as it would be found during normal furnace operations when it is not being used to take measurements. The portal 5 is closed. The probe housing 10 is oriented toward the portal 5 and the cartridge pole 22 is fully retracted within the housing 10.

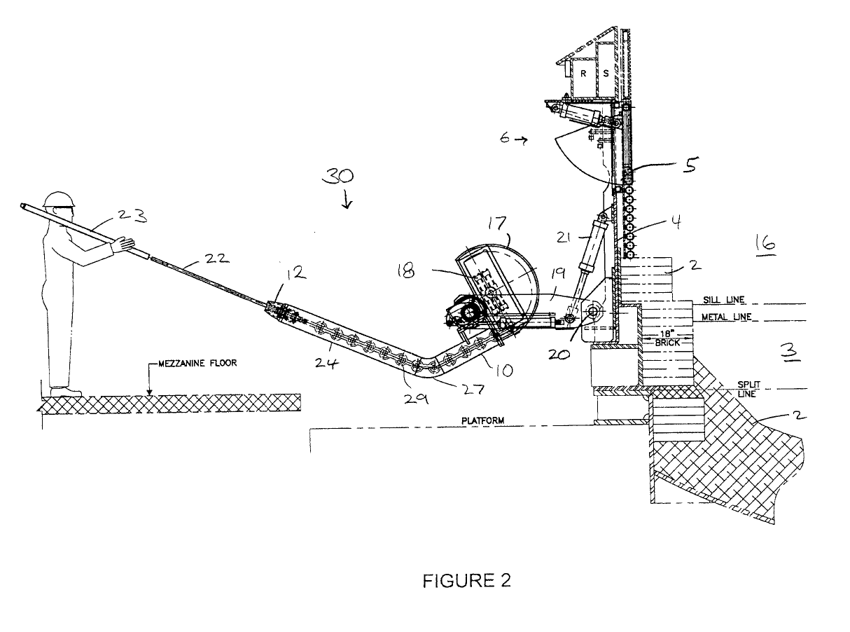

In FIG. 2, the housing 10 is rotated fully away from the furnace and the pole 22 has been extended out of the linear portion 24 of the housing 10 so that a worker can mount a cartridge 23 onto the pole 22.

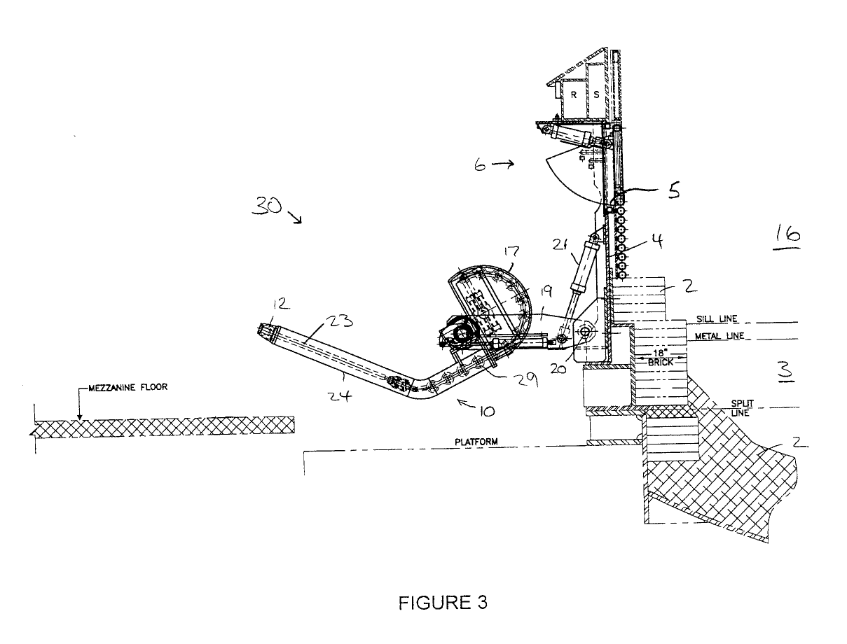

In FIG. 3, the worker has left the area, and the pole 22 has been withdrawn into the housing 10 along with the cartridge 23.

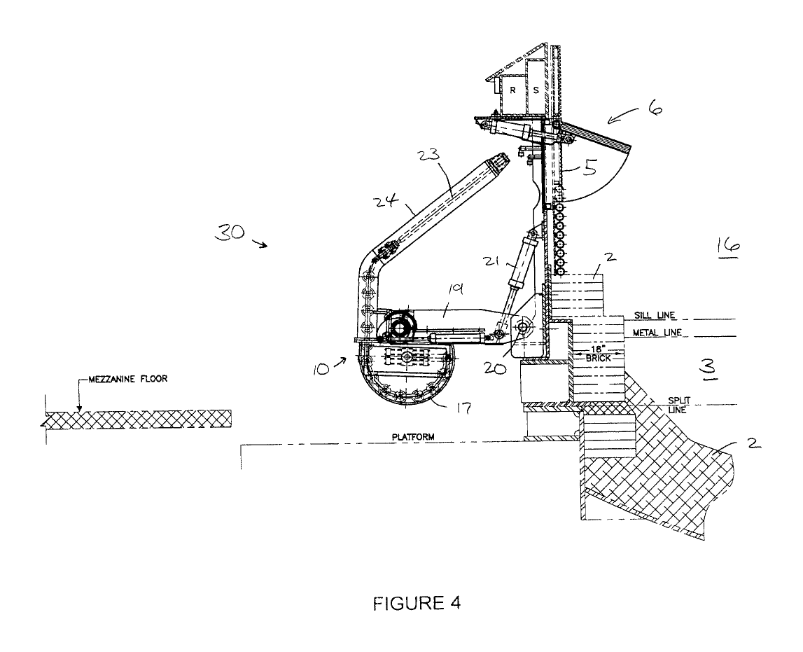

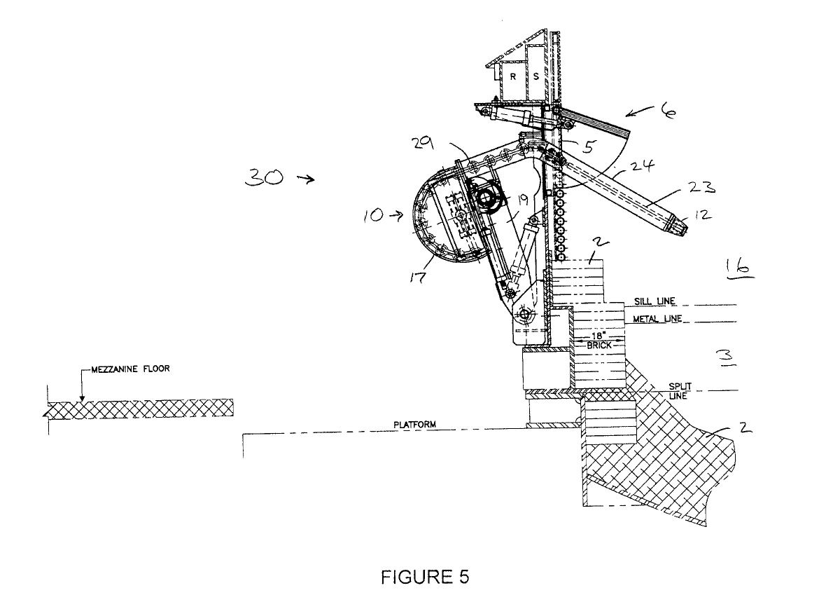

In FIG. 4, the housing 10 has been rotated upwardly as in FIG. 1, and the probe insertion assembly 15, with the cartridge 23 on the pole 22 inside the housing is about to move from a standby position into a measurement position. The portal is already opened to allow the linear portion 24 of the housing 10 within the furnace. FIG. 5 shows the next subsequent step where the linear portion 24 of the housing 10 has entered the furnace through the portal 5.

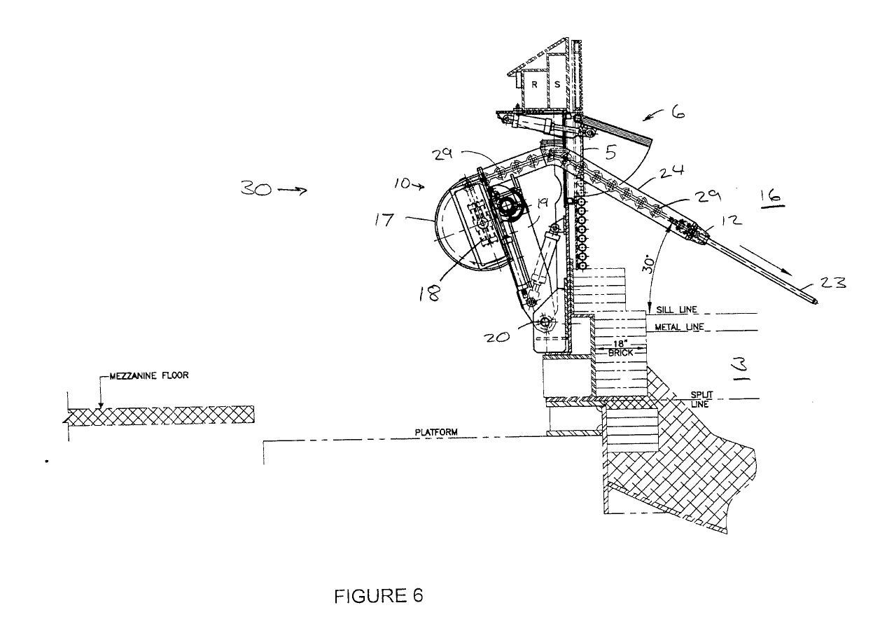

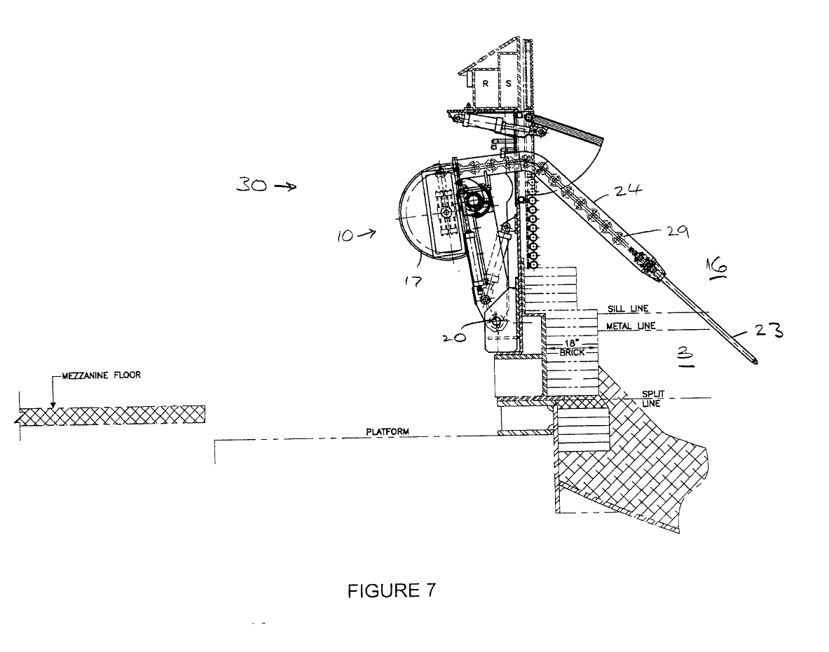

In FIG. 6, the pole 22 bearing the cartridge 23, which is about to take measurements, has been extended outside of the housing 10. In FIG. 7, the housing 10 has been rotated further so that the cartridge 23 is immersed in the bath.

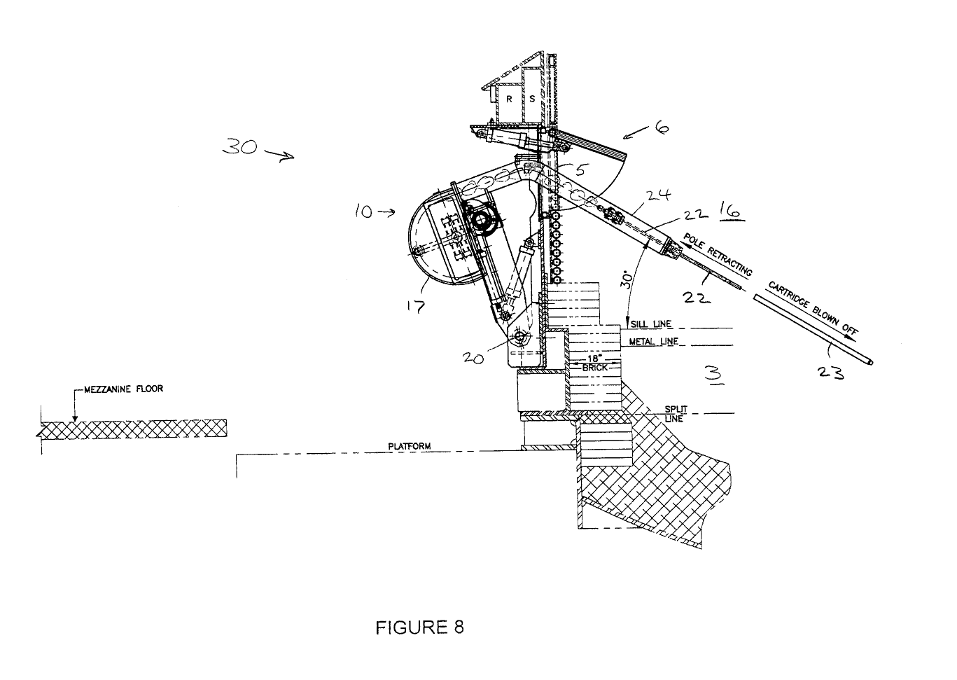

In FIG. 8, the probe housing 10 has been rotated upwardly somewhat while the pole 22 has been retracted somewhat. Concurrently, a jet of compressed air is been expelled through the pole 22, which is tubular, to eject the cartridge 23. Discarding the cartridge 23 into the bath of molten metal has no effect on the metallurgical operations.

The probe insertion assembly 15 is subsequently rotated back to the position shown in FIG. 1 and the portal 5 is similarly closed as in FIG. 1.

It will of course be appreciated by persons skilled in the art that many variations are possible within the scope of the claimed subject matter. For example, although the above-noted embodiment has been described as having a compressed gas supply for blowing the cartridge off the mounting pole, a variety of alternatives would be available. These include having an extendable element for pushing the cartridge off of the pole, or having a collar or other barrier to strip the cartridge off the pole as it is withdrawn into the housing.

1. A mechanical probe apparatus for taking measurements with a sensor cartridge inside a metallurgical furnace, comprising:
a housing;
a mounting member adapted to releasaiDly receive the sensor cartridge, the mounting member being movable from a normal first position wherein it is withdrawn in the housing, to a second position wherein it extends outside of the housing;
said housing being movable between a position entirely exterior of the furnace, to a position wherein a portion of the housing extends into the furnace through a dedicated probe portal;
a closure for substantially closing the portal when the housing is in a position exterior of the furnace;
wherein the mounting member can be moved to either its first or second position both when the housing is in a position entirely exterior of the furnace and when the housing is in the position wherein a portion of the housing extends into the furnace,
such that when the housing is in a position entirely exterior of the furnace and the mounting member is moved to its second position, the sensor cartridge can be mounted to the mounting member and then withdrawn into the housing as the mounting member is moved to its first position,
and such that when the housing is subsequently moved to the position wherein a portion of the housing extends into the furnace, the sensor cartridge can be extended outside of the housing to take measurements as the mounting member is moved to its second position; and
an ejector for releasing the sensor from the mounting member when the housing is in the position wherein a portion of the housing extends into the furnace, after the measurements have been taken.

2. The apparatus of claim 1, wherein the ejector comprises a compressed gas supply for blowing the sensor off of the mounting member after the measurements have been taken.

3. The apparatus of claim 1, wherein the ejector comprises a barrier for stripping the sensor off of the mounting member as the mounting member is withdrawn back into the housing after the measurements have been taken.

4. The apparatus of claim 1, wherein the ejector comprises an extendable element for pushing the sensor off of the mounting member after the measurements have been taken.

5. The apparatus of claim 4, wherein the portal is dimensioned to closely accommodate the portion of the housing extending into the furnace.

6. The apparatus of claim 5, wherein the furnace has a slag door and the portal is separate from the slag door.

7. The apparatus of claim 6, wherein the portal is remote from the slag door.

8. The apparatus of claim 1, wherein the housing is mounted on an arm that pivots.

9. The apparatus of claim 8, wherein the housing rotates on the pivoting arm.

10. The apparatus of claim 9, wherein both the arm pivots and the housing rotates on a substantially vertical plane.

11. The apparatus of claim 10, wherein the housing has a linear portion.

12. The apparatus of claim 11, wherein the housing also has a curved portion from which the linear portion extends.

13. The apparatus of claim 12, wherein the mounting member comprises a pole.

14. The apparatus of claim 13, wherein the pole is tubular.

15. The apparatus of claim 14, wherein the pole can be pushed and pulled within the housing by means of a linkage.

16. The apparatus of claim 15, wherein the linkage comprises a roller chain.

17. The apparatus of claim 16, wherein the roller chain is activated by a rotary actuator.

18. The apparatus of claim 12, wherein the housing includes a liquid-cooling circuit.

19. The apparatus of claim 12, wherein the housing further comprises a compressed air supply.

20. (canceled)

21. The apparatus of claim 1, further comprising a control system for automatically controlling the movement of the housing, and for controlling the opening and closing of the closure of the portal, and for controlling the extension and retraction of the mounting member.
